(19) United States
(12) Patent Application Publication
(10) Pub. No.: US 2010/0035712 A1
(43) Pub. Date: Feb. 11, 2010

(54) ATTACHMENT ARRANGEMENT FOR A TRACTION MECHANISM TENSIONER

(75) Inventors: Bernd Hartmann, Weisendorf (DE); Stefan Mack, Erlangen (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/366,171

(22) Filed: Feb. 5, 2009

(30) Foreign Application Priority Data
Feb. 27, 2008 (DE) 102008011369.7

(51) Int. Cl. F16H 7/12

(52) U.S. Cl. 474/110; 474/135

(57) ABSTRACT

An attachment arrangement (1) for a traction mechanism tensioner (3, 3′) on a motor vehicle is provided, wherein the traction mechanism tensioner (3, 3′) has a tensioning unit (30, 30′) that is in active connection with a lever unit (31, 31′) on which lever unit (31, 31′) a tensioning element (32, 32′) is mounted, and wherein, on the motor vehicle, at least one attachment point (10, 11) is provided both for the tensioning unit (30, 30′) and also for the lever unit (31, 31′). The attachment points (10, 11) are oriented on the motor vehicle and relative to each other such that the attachment points (10, 11) are suitable for the operational attachment of both a hydraulically damped traction mechanism tensioner (3) and also a mechanically damped traction mechanism tensioner (3′).

### CROSS-REFERENCE TO RELATED APPLICATIONS

This application claims the benefit of DE 10 2008 011 369.7, filed Feb. 27, 2008, which is incorporated herein by reference as if fully set forth.

### FIELD OF THE INVENTION

The invention relates to an attachment arrangement for a traction mechanism tensioning devices or tensioners on a motor vehicle, wherein the traction mechanism tensioner has a tensioning unit that is in active connection with a lever unit on which a tensioning element is mounted and wherein at least one attachment point is provided on the motor vehicle both for the tensioning unit and also for the lever unit.

### BACKGROUND

Traction mechanism drives, such as, for example, belt drives, have proven to be preferred means for driving auxiliary assemblies in modem motor vehicle engines. Such auxiliary assemblies can be, for example, complex valve trains, compensation shafts, oil pumps, water pumps, generators, air-conditioner compressors, or also a power-steering system. Due to repeated loading and unloading cycles and also due to aging, the tightness of the traction mechanism decreases over time. In order to ensure that the traction mechanism can guarantee problem-free driving of the add-on components over the entire service life of this traction mechanism despite aging, traction mechanism tensioners are used. In this way, according to the application or load, mechanical or hydraulic tensioners can be used.

Despite ever increasing packaging complexity, in order to ensure the total functional behavior of a traction mechanism drive, traction mechanism tensioners designed especially for each vehicle model have become a necessity. During the structural design process of engine assemblies, it can definitely happen that the originally assumed requirements on the traction mechanism tensioner change. There is even the possibility that a traction mechanism tensioner already selected will prove to be no longer optimum in retrospect, that is, for example, during the development of the vehicle or else also for its model improvements after it is introduced to the market and a change to a suitable traction mechanism tensioner or the retrofitting to a suitable traction mechanism tensioner (damped mechanically instead of hydraulically or conversely) would actually be preferred.

In front of this background, in DE 195 24 403 C2 a support featuring special friction damping for the arm of the lever unit of a belt tensioner is described that can be produced based on specified properties with the same dimensions as known supports (at the time of filing of the document). In this way it should be also possible to retrofit already existing traction mechanism tensioners without a problem and economically.

### SUMMARY

The invention is based on the objective of providing an attachment arrangement for traction mechanism tensioners, wherein this device allows exchangeability between a mechanically damped and a hydraulically damped traction mechanism tensioner without significant expense.

The invention is based on the knowledge that the structural design of the attachment for a traction mechanism tensioner effects exchangeability.

The invention therefore starts with an attachment arrangement for a traction mechanism tensioner on a motor vehicle, wherein the traction mechanism tensioner has a tensioning unit that is in active connection with a lever unit on which a tensioning element is mounted and wherein, on the motor vehicle, at least one attachment point is provided both for the tensioning unit and also for the lever unit. In addition, according to the invention it is provided that the attachment points are oriented on the motor vehicle and relative to each other such that these are suitable for functional attachment of both a hydraulically damped traction mechanism tensioner and also a mechanically damped traction mechanism tensioner.

Furthermore, traction mechanism tensioners are proposed that are suitable for attachment with the attachment arrangement according to the invention.

Through this construction it is achieved that exchangeability of the traction mechanism tensioner (damped mechanically or damped hydraulically or conversely) is possible through a relatively simple hand movement without requiring the introduction of a new, very cost-intensive design and testing process for the engine assembly.

Preferred improvements or configurations of the invention are described below and in the claims.

According to a first improvement of the invention, it is provided that the attachment arrangement comprises at least two attachment points, wherein one attachment point is constructed for the attachment of the tensioning unit and the other attachment point is constructed for the attachment of the lever unit. In this way, the attachment arrangement can be kept simple in terms of structure, wherein, nevertheless, a secure attachment is guaranteed.

Another advantageous configuration of the invention provides that at least the lever unit is mounted at the other attachment point such that rotational movement or pivoting movement of the lever unit about the attachment point is provided.

For a mechanically damped tensioner, the rotational movement of the lever unit about this attachment point is damped by mechanical friction in the tensioner, while for a hydraulically damped tensioner, the rotational movement about this attachment point is damped by the pressing of oil through a leakage gap in the tensioner. In this way, the damping properties of both tensioners are fundamentally different, wherein one or the other type of tensioner can be advantageous for the specific traction mechanism drive.

Finally, both a hydraulic and also a mechanical traction mechanism tensioner are proposed each with a tensioning unit that is in active connection with a lever unit on which tensioning elements are mounted, wherein both the tensioning unit and also the lever unit each have at least one attachment opening, and wherein, alternatively, either the hydraulically damped or the mechanically damped traction mechanism tensioners can be functionally attached with the attachment openings of the attachment arrangement according to the invention (i.e., operational according to its normal function).

### BRIEF DESCRIPTION OF THE DRAWINGS

The invention will be explained in greater detail below with reference to the accompanying drawing using a preferred embodiment. Shown therein are:

FIG. 1 is a greatly simplified schematic diagram that shows the attachment arrangement according to the invention on an engine assembly of a motor vehicle in top view,

FIG. 2 is a view of an embodiment for a hydraulically damped traction mechanism tensioner that can be attached with the attachment arrangement according to the invention, and

FIG. 3 is a view of an embodiment for a mechanically damped traction mechanism tensioner that can be attached with the attachment arrangement according to the invention.

### DETAILED DESCRIPTION OF THE PREFERRED EMBODIMENTS

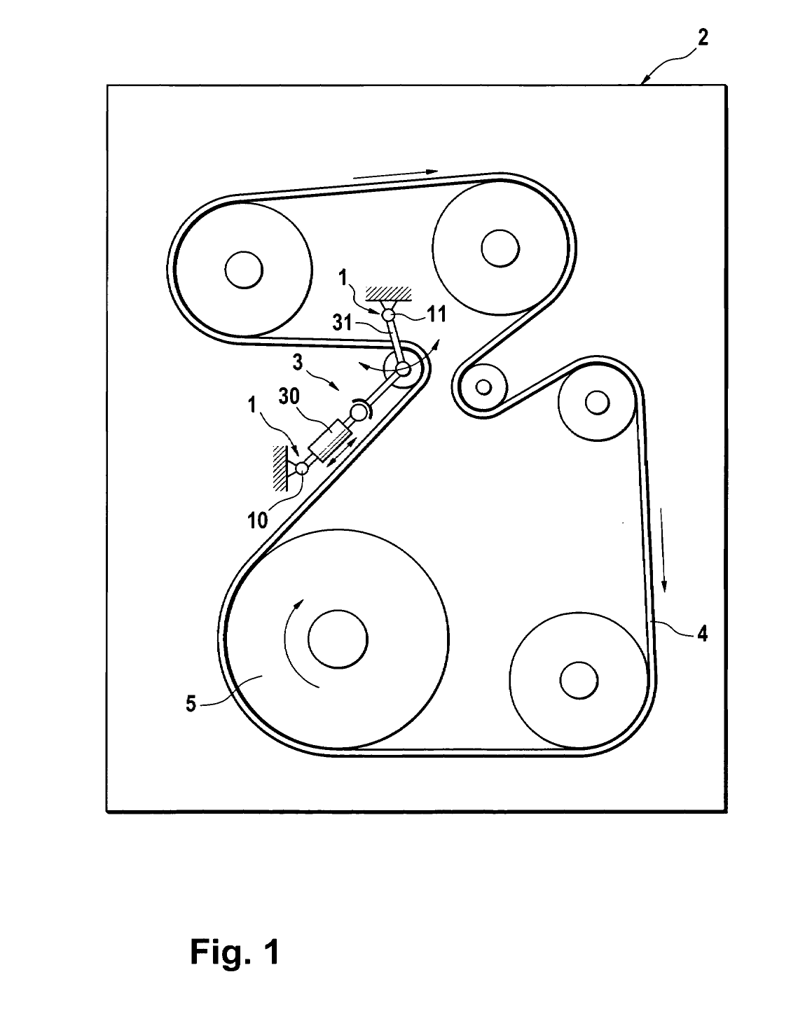

In FIG. 1, an engine assembly 2 of a motor vehicle (not shown) is shown schematically on which a crank drive 5 drives a traction mechanism 4. Auxiliary assemblies, such as, e.g., oil pumps, water pumps, generators, air-conditioner compressors, or also the power-steering system, which are represented only by their belt disks, are simultaneously driven by the traction mechanism 4. Furthermore, a hydraulically damped traction mechanism tensioner 3 is visible that tensions the traction mechanism 4. This traction mechanism tensioner 3 comprises a hydraulic tensioning and damping unit 30 and a lever unit 31, wherein these units (30, 31) are in active connection with each other. The lever unit 31 is supported so that it can rotate about an attachment point 11 to the engine assembly 2. The tensioning and damping unit 30 is mounted, in contrast, on an attachment point 10 of the engine assembly 2.

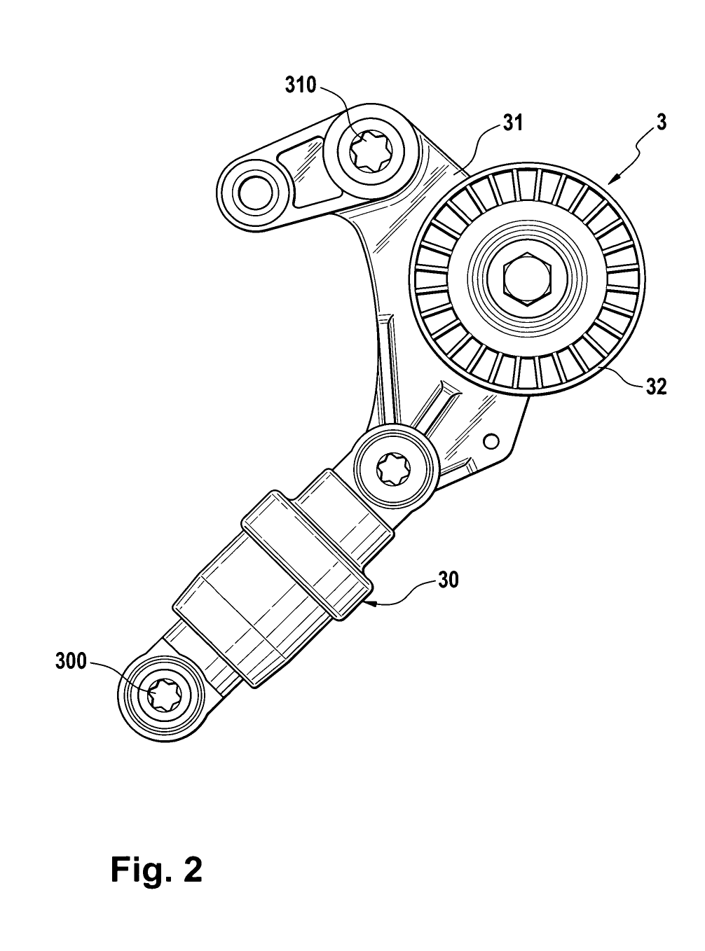

FIG. 2 now shows the hydraulically damped traction mechanism tensioner 3 in detail, wherein the hydraulic tensioning and damping unit 30 and the lever unit 31 can be clearly seen. Furthermore, a receptacle 32 for tensioning element for contact against the traction mechanism 4 is visible, wherein the not-shown tensioning element is constructed as a tensioning roller mounted rotatably on the lever unit 31. The lever unit 31 has an attachment opening 310 and the hydraulic tensioning and damping unit 30 has an attachment opening 300, wherein with these openings (310, 300) the traction mechanism tensioner 3 can be attached with the attachment arrangement 1 according to the invention.

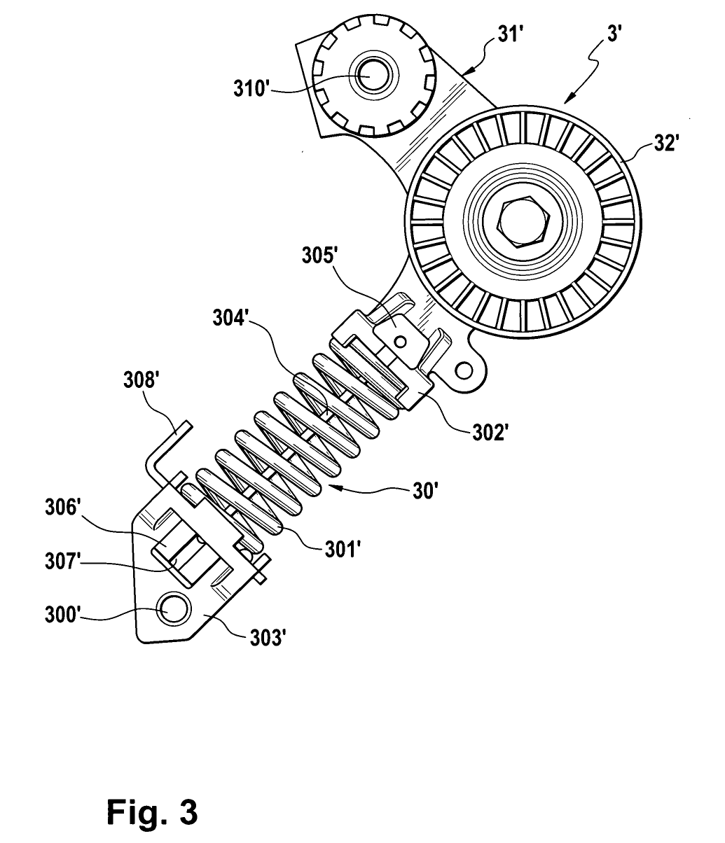

FIG. 3 shows an alternative, mountable, mechanically damped traction mechanism tensioner 3′ with a receptacle 32′ for not-shown tensioning element in the form of a tensioning roller on the lever unit 31′ that is in active connection with a mechanical tensioning unit 30′. The damping of the movement of the lever unit 31 about the attachment point 310′ is realized by a not further shown, but known friction element in the region of this lever unit 31.

The mechanical tensioning unit 30′ is formed by a coil compression spring 301′ that is held by an upper spring receptacle 302′ and a lower spring receptacle 303′. The coil compression spring 301′ coaxially surrounds a stiff securing wire 304′ that has an approximately round construction in cross section and two angles pointing in the same direction in the side longitudinal section (not shown). With the upper angle, the securing wire 304′ engages in an insert element 305′ inserted into the upper spring receptacle 302′ and with the lower angle, the securing wire 304′ engages in a guide slot 307′ of a guide sleeve 306′ that is pushed into the lower spring receptacle 303′.

Furthermore, a securing splint 308′ can be seen by which the coil compression spring 301′ is held under pretension during transport and during the assembly of the traction mechanism tensioner 3′. This simplifies installation and transport of the mechanical traction mechanism tensioner 3′ at the installation site. After installation, the securing splint 308′ can be removed, so that the coil compression spring 301′ is extended and the not-shown tensioning roller presses against the traction mechanism and tensions this traction mechanism. Furthermore, on the lever unit 31′ and on the tensioning unit 30′, attachment points 310′ and 300′ can be seen, respectively, with which the traction mechanism tensioner 3′ can be attached with the attachment arrangement 1 according to the invention.

### LIST OF REFERENCE SYMBOLS

1 Attachment arrangement

2 Engine assembly of a motor vehicle

3 Traction mechanism tensioner, hydraulic

30 Hydraulic tensioning and damping unit

31 Lever unit

32 Tensioning means

300 Attachment point of the tensioning unit

310 Attachment point of the lever unit

3′ Traction mechanism tensioner, mechanical

30′ Mechanical tensioning unit

31′ Lever unit

32′ Tensioning means

300′ Attachment point of the tensioning unit

301° Coil compression spring

302′ Upper spring receptacle

303′ Lower spring receptacle

304′ Securing wire

305′ Insert element

306′ Guide sleeve

307′ Guide slot

308′ Securing splint

310′ Attachment point of the lever unit

4 Traction mechanism

5 Crank drive

10 Attachment point on motor vehicle

11 Attachment point on motor vehicle

1. An attachment arrangement for a traction mechanism tensioner on a motor vehicle, comprising a traction mechanism tensioner having a tensioning unit that is in active connection with a lever unit on which lever unit a tensioning element is mounted, and on the motor vehicle, at least one attachment point is provided both for the tensioning unit and also for the lever unit, the attachment points are oriented on the motor vehicle and relative to each other such that the attachment points are suitable for the operational attachment of the traction mechanism tensioner, which comprises either of a hydraulically damped traction mechanism tensioner and a mechanically damped traction mechanism tensioner.

2. The attachment arrangement according to claim 1, wherein the attachment arrangement comprises at least two attachment points, wherein a first one of the attachment points is constructed for attachment of the tensioning unit and the second one of the attachment points is constructed for attachment of the lever unit.

3. The attachment arrangement according to claim 2, wherein at least the lever unit is attached at the second attachment point such that a rotational movement of the lever unit about the second attachment point is possible.

4. Hydraulic traction mechanism tensioner comprising a tensioning unit that is in active connection with a lever unit on which a tensioning element is mounted, wherein both the tensioning unit and also the lever unit each have at least one attachment point, the hydraulic traction mechanism tensioner can be attached operationally with the attachment openings to an attachment arrangement having attachment points oriented on a motor vehicle and relative to each other such that the attachment points are suitable for the operational attachment of the hydraulic traction mechanism tensioner or a mechanically damped traction mechanism tensioner.

5. Mechanical traction mechanism tensioner comprising a tensioning unit that is in active connection with a lever unit on which a tensioning element is mounted, wherein both the tensioning unit and also the lever unit each have at least one attachment opening, the mechanical traction mechanism tensioner can be operationally attached with the attachment openings to an attachment arrangement having attachment points oriented on a motor vehicle and relative to each other such that the attachment points are suitable for the operational attachment of the mechanical traction mechanism tensioner or a hydraulically damped traction mechanism tensioner.
